(19) United States
(12) Patent Application Publication
(10) Pub. No.: US 2022/0398327 A1
(43) Pub. Date: Dec. 15, 2022

(54) APPLYING NOISE TO FORMATS WITH MASKING RESTRICTIONS

(71) Applicant: International Business Machines Corporation, Armonk, NY (US)

(72) Inventors: Ariel FARKASH, Shimshit (IL); Micha Gideon MOFFIE, Zichron Yaakov (IL)

(21) Appl. No.: 17/344,487

(22) Filed: Jun. 10, 2021

(51) Int. Cl. G06F 21/60; G06F 16/11

(52) U.S. Cl. CPC G06F 21/602; G06F 16/116

(57) ABSTRACT

An example system includes a processor to receive an instance of a format and a masking restriction. The processor can rank the instance of the format to generate an integer in an effective domain of the format. The processor can apply noise to the integer based on the masking restriction to generate a perturbed integer. The processor can unrank the perturbed integer to generate a second instance of the format.

### BACKGROUND

The present techniques relate to masking of data. More specifically, the techniques relate to masking formats in data. For example, a format may be any user-defined data format. Examples of data formats are dates, integers.

Format-preserving encryption (FPE) or format preserving tokenization (FPT) are sometimes used when there are format restrictions on a masking output. Such methods create a valid value in the domain that cannot be traced back to the original value, purposefully removing any utility or statistical relation to the original value. However, sometimes the security need for cryptographic strength is not required, but there may exist a need to perturb the values. In other words, a system may just need noise to be added to the original value. Although not as secure as a cryptographic transformation and may not maintain statistical value for analytical purposes, such perturbation may supply some utility, and for some applications such utility is permissible and may even be useful.

### SUMMARY

According to an embodiment described herein, a system can include processor to receive a first instance of a format and a masking restriction. The processor can also further rank the first instance of the format to generate an integer in an effective domain of the format, where the effective domain of the format is reduced from an original domain of the format by the masking restriction. The processor can also apply noise to the integer based on the masking restriction to generate a perturbed integer. The processor can unrank the perturbed integer to generate a second instance of the format. Thus, the system enables noise to be applied to instances of formats within masking restrictions. Optionally, the perturbed integer is a number within a percentage of a size of the effective domain of the format. In this embodiment, the system enables a perturbation within a percentage and conforming to the masking restriction. Preferably, the noise is generically applied to the first instance of the format by modifying the integer corresponding to the first instance of the format and generating the perturbed integer. In this embodiment, the system supports various formats in a generic fashion. Optionally, the format includes a composite format, and the processor is to rank the first instance of the format using a composite ranking. In this embodiment, the system enables noise to be applied to composite formats within masking restrictions. Preferably, the second instance of the format includes a valid instance of the format within the masking restriction. In this embodiment, the system enables format restrictions and any other validations to be maintained on the second instance. Preferably, the effective domain includes an ordered set of possible valid values for the format within the masking restriction based on the first instance of the format. In this embodiment, the system can maintain instance-specific masking restrictions. Optionally, the format includes a tiled format and the masking restriction includes keeping the second instance of the format within an original tile of the first instance, where an effective size of the effective domain of the format includes a size of the tile. In this embodiment, the system enables tiled masking restrictions.

According to another embodiment described herein, a method can include receiving, via a processor, a first instance of a format and a masking restriction. The method can further include ranking, via the processor, the first instance of the format to generate an integer in an effective domain of the format, where the effective domain of the format is reduced from an original domain of the format by the masking restriction. The method can also further include applying, via the processor, noise to the integer based on the masking restriction to generate a perturbed integer. The method can also include unranking, via the processor, the perturbed integer to generate a second instance of the format. Thus, the method enables noise to be applied to instances of formats within masking restrictions. Preferably, applying the noise includes generating an effective domain for the first instance of the format based on the masking restriction and generating the perturbed integer within the effective domain. In this embodiment, the system can maintain instance-specific masking restrictions. Optionally, ranking the first instance of the format includes performing a composite ranking, where the format includes a composite format. In this embodiment, the method enables noise to be applied to composite formats within masking restrictions. Optionally, applying the noise to the integer based on the masking restriction includes perturbing the integer within a percentage of a size of the effective domain of the format. In this embodiment, the method enables a perturbation within a percentage that stays within a masking restriction. Optionally, applying the noise to the integer based on the masking restriction includes perturbing the integer within a range corresponding to a tile corresponding to the first instance of the format. In this embodiment, the system enables tiled masking restrictions. Optionally, applying the noise to the integer based on the masking restriction includes keeping immutable sub-format values unchanged. In this embodiment, the system enables immutable masking restrictions. Optionally, the method includes transmitting, via the processor, the second valid instance of the format to an application to be used as test data. In this embodiment, the method enables test data to be efficiently generated.

According to another embodiment described herein, a computer program product for masking formats can include computer-readable storage medium having program code embodied therewith. The computer readable storage medium is not a transitory signal per se. The program code executable by a processor to cause the processor to receive a first instance of a format and a masking restriction. The program code can also cause the processor to rank the first instance of the format to generate an integer in an effective domain of the format, where the effective domain of the format is reduced from an original domain of the format by the masking restriction. The program code can also cause the processor to apply noise to the integer based on the masking restriction to generate a perturbed integer. The program code can also cause the processor to unrank the perturbed integer to generate a second instance of the format. Thus, the program code enables noise to be applied to instances of formats within masking restrictions. Preferably, the program code can also cause the processor to generate the perturbed integer within the effective domain of the format based on the masking restriction. Optionally, the program code can also cause the processor to perform a composite ranking, where the format includes a composite format. In this embodiment, the computer product enables noise to be applied to composite formats within masking restrictions. Preferably, the program code can also cause the processor to perturb the integer within a percentage of a size of the effective domain of the format. In this embodiment, the system enables a perturbation within a percentage that stays within a masking restriction. Optionally, the program code can also cause the processor to perturb the integer within a range corresponding to a tile corresponding to the instance of the format, where the format includes a tiled composite format and the effective domain includes the tile of the instance. In this embodiment, the computer product enables tiled masking restrictions. Optionally, the program code can also cause the processor to transmit the second instance of the format to an application for use as test data. In this embodiment, the computer product enables test data to be efficiently generated.

### BRIEF DESCRIPTION OF THE SEVERAL VIEWS OF THE DRAWINGS

FIG. 1 is a block diagram of an example system for masking formats with masking restrictions;

FIG. 2 is a block diagram of an example method that can mask formats with masking restrictions;

FIG. 3 is a block diagram of an example computing device that can mask formats with masking restrictions;

FIG. 4 is a diagram of an example cloud computing environment according to embodiments described herein;

FIG. 5 is a diagram of an example abstraction model layers according to embodiments described herein; and

FIG. 6 is an example tangible, non-transitory computer-readable medium that can mask formats with masking restrictions.

### DETAILED DESCRIPTION

Noise may be sometimes added to data for a variety of reasons. While adding noise may be a relatively straightforward procedure for simple types of data, there may be additional complications involved in adding noise to composite formats composed of various types of data. Moreover, adding noise to mixed types of data may be especially difficult when the composite format transformation includes masking restrictions to be met. Masking restrictions may be used to define a valid transformation. For example, a masking restriction for the IP format, that is built from both IPv4 and IPv6 formats, may be expressed as IPv4=>IPv4 and IPv6=>IPv6. Thus, per this masking restriction, an IPv4 may be validly transformed into another IPv4 and not into an IPv6 format.

According to embodiments of the present disclosure, a system includes a processor to receive a first instance of a format and a masking restriction. A format, as used herein, refers to a data type that is able to search, match and rank. Search, as used herein, refers to a function that a format can use to find instances itself in data such as text. Match, as used herein, refers a function that can validate that a detected instance is a valid instance of the format by validating any format restrictions that may be part of the format. Rank, as used herein, refers to a function that maps an instance to an integer in a consistent manner. For example, a rank may index an instance of a format into an integer that represents a relative place of the instance with respect to all possible instances of the format. Masking restrictions, as used herein, refer to restrictions on a valid transformations of format instances. Masking restrictions have no relation to the validity of an instance of a format, but rather may constrain the changes allowable to an input instance. Thus, unlike format restrictions, masking restrictions do not change the validity of a format instance in the output or the input. For example, the instance of the format may be a valid instance of the format. A valid instance of a format may comply with any format restrictions for the format. As one example, a format restriction may be a Luhn checksum validation that restricts the number of valid instances to 1/10 of the total number of possible instances for a particular format. The processor can rank the instance of the format to generate an integer in an effective domain of the format. In some examples, the format may be a composite format. A composite format, as used herein, is defined as a hierarchical composition of sub-formats in a recursive manner. Each sub-format of the composite format is a format, and an instance of a composition format or a building block. A building block is a sub-format basic building block of a composite format. In such a framework, each building block may be implemented so that it can match, search and rank itself. The processor can apply noise to the integer based on the masking restriction to generate a perturbed integer. The processor can then unrank the perturbed integer to generate a second instance of the format. Thus, embodiments of the present disclosure allow noise to be generically generated for masking a variety of formats in a format-preserving manner that preserves format restrictions, while also maintaining masking restrictions. For example, composite formats relating to integers may be able to be handled in the same manner as composite formats related to dates or other types of data. In addition, the embodiments may be able to handle simple building block formats in the same manner as composite formats and thus provide a generic approach to masking formats of various types within certain masking restrictions while maintaining the format restrictions. Moreover, the embodiments provide for a cipher operation that is decoupled from the masking restriction. Thus, for any cipher operation, such as format-preserving encryption (FPE) or format-preserving tokenization (FPT), this will still hold. If FPE is used, then an encrypted mask can be decrypted using an encryption key. Thus, FPE may be described as reversible.

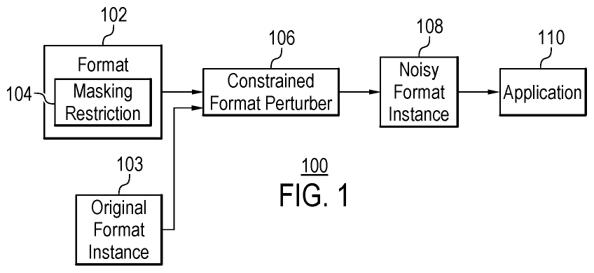

With reference now to FIG. 1, a block diagram shows an example system for masking formats with masking restrictions. The example system is generally referred to by the reference number 100. The system 100 includes a format 102 and an original format instance 103. For example, the format 102 may be any user-defined data format that is able to match, search, and rank. In some examples, the format 102 may be a composite format. For example, the composite format may be a combination of sub-formats, which may include another composite format, building blocks, or any combination thereof. The original format instance 103 is a particular instance of format 102. For example, the original format instance 103 may be received from a search or matching algorithm (not shown). The format 102 includes a masking restriction 104. For example, the masking restriction 104 may be a tiled composition masking restriction. The system 100 also includes a constrained format perturber 106 shown receiving the format 102. The constrained format perturber 106 is also shown generating a noisy format instance 108. For example, the noisy format instance 108 may be an instance of the format 102 with a different value than the instance received by the constrained format perturber 106, but a value that is valid with respect to both any format restrictions and the masking restriction 104. The system 100 also further includes an application 110 communicatively coupled to the constrained format perturber 106 and shown receiving the noisy format instance 108.

In the example of FIG. 1, the constrained format perturber 106 may receive a format 102 with an associated masking restriction 104, and an original format instance 103, and generate a noisy format instance 108 from the original format instance 103 based on the masking restriction 104. In various examples, the constrained format perturber 106 can transmit the noisy format instance 108 to a downstream application 110 that performs data validation. For example, the application 110 may validate the noisy format instance 108 by using the noisy format instance 108 instance as test data.

Still referring to FIG. 1, constrained format perturber 106 may perform a masking operation that receives instances 103 of a given format 102 and a given masking restriction 104 for the format 102. In various examples, the constrained format perturber 106 may rank the original format instance 103. For example, the constrained format perturber 106 can use a composite ranking that determines a domain of the format 102 including all possible instances of the format 102 and their corresponding index. The constrained format perturber 106 can then rank the original format instance 103 of the format 102 to generate an integer corresponding to the index of the received original format instance 103. In various examples, the ranking may be aligned with the actual values of the format 102, such as in the case of the formats Integer, String, and Date. An example list of building block format types, along with sample instances is shown in the table below:

| Building Block Types | Example Instances |
|---|---|
| Integer[Min, Max] | 134 |
| FixedLengthPaddedInteger[Min, Max, Length] | 0012 |
| RealNumber[Min, Max, Precision] | 23.45 |
| FixedLengthString[Alphabet, Length] | ABCDE, abcde |
| VariableLengthString[Alphabet, MinLen, MaxLen] | ABC, ABCD, abcde |
| RegularExpression | \d{2,5}\.[A-Z]{3} |
| StringSet | [David, Jason, Michael] |
| TextBased [any text] | Ab56, $134 |

In various examples, the building block formats Integer[Min,Max], FixedLengthPaddedlnteger[Min, Max, Length], RealNumber[Min, Max, Precision], may be ranked using any suitable integer domain ranking algorithm. The format FixedLengthString[Alphabet, Length], VariableLengthString[Alphabet, MinLen, MaxLen], may be ranked using any suitable lexicographic ranking algorithm. The building block format RegularExpression may be ranked using a state machine. The format StringSet may be ranked using an enumeration ranking algorithm. The format TextBased [any text] may be ranked using a state machine.

In various examples, the constrained format perturber 106 can then perturb the integer based on the masking restriction to generate a perturbed integer, referred to herein as a masked rank. For example, the constrained format perturber 106 can apply a perturbation on the integer using a percentage of the domain size of the format 102 as a parameter to generate the masked rank. In various examples, the constrained format perturber 106 can then unrank the resulting masked rank to generate a legal string within the domain of the format 102. For example, the legal string may have an index within the domain corresponding to the perturbed integer. In this manner, the constrained format perturber 106 can generate a noisy format instance 108 that is a second instance of the format 102. Thus, the format 102 and its restrictions are preserved in the noisy format instance 108. In addition, the masking restriction 104 is also maintained during the transformation of the original format instance 103 to the noisy format instance 108.

In one example, a column in a database may represent values for a parameter in a particular format. For example, the format may be a tiled composite format of integer ranges, as shown in the sample format definition below:

```
“formats”: [
  {
  “id”: “Class_Size”
  “format”: {
    “type”: “Tiled”,
    “configuration: {
      “subformats”: [
        {
          “type”: “Integer”,
          “configuration”: {
            “min”: 10,
            “max”: 20
          }
        }.
        {
          “type”: “Integer”,
          “configuration”: {
            “min”: 21,
            “max”: 30
          }
        },
        {
          “type”: “Integer”,
          “configuration”: {
            “min”: 31,
            “max”: 35
          }
        },
        {
          “type”: “Integer”,
          “configuration”: {
            “min”: 36,
            “max”: 40
          }
        }.
      ]
```

In addition, the same table may have a column representing a band of a second parameter, such as teachers. For example, school may have a policy that each band of the teachers is mapped to a non-overlapping set of ranges for the class size in the first column. In various examples, the embodiments described herein may be used to mask the values of the class size column without changing the band range of the original values with which the class size values are associated. For example, a teacher in the band associated with 10-20 will always receive a value in that band range, and a teacher in the band associated with the range 36-40 will similarly always receive a value in that range. A masking requirement for creating test data for this table and column may therefore be that the values of each column remain within the same original range of the ranges specified in the format. Thus, a masking restriction for the values in this particular example may be that the masked values remain in their original band ranges. For example, the ranges may be 10-20, 21-30, and so forth. An additional requirement for creating the test data may be that the values in the test data change no more than 2% from the original input values. Thus, a value of 2% maximum value change may also be in the masking restriction. In this example, for an input value of 17, a simple noise generation may suffice, since the output value would fall within the allowed 10-20 range. However, a simple noise generation on the input value of 21 may be problematic because the output value may fall below 21, which would violate the masking restrictions by falling into a different range of 10-20. Thus, using the embodiments described herein, a transformation is applied on the rank, and the rank transformation would therefore be limited to its allowed ranged in the masking restriction, referred to as an effective domain. For example, the effective domain may be a tile size in this case, and thus the output value would always fall within the corresponding range. Another specific example may be in a database used for prescription of glasses, as shown in the format definition below:

```
“format”: {
  “type”: “Concatenation”,
  “configuration: {
    “subformats”: [
      {
        “type”: “Immutable”,
        “configuration”: {
          “subformat”: {
            “type”: “StringSet”
            “configuration”: {
              “set”: [
                “Left”,
                “Right”
              ].
              “ignoreCase”: false
            }
          }
        }
      },
      {
        “type”: “RealNumber”,
        “configuration”: {
          “min”: -9,
          “max”: 9
          “scale”: 2
        }
      }
    ]
  }
}
```

For example, valid values in this above concatenated type composite format may be: “Left 3.57”, “Right −2.40”, “Left −1.47”. The requirement in this example may be to perturb the prescription value by no more than 5%, but not change the associated eye of each of the values being masked. Because the example format includes an Immutable sub-format, a transformation using the embodiments described herein using the masking restriction corresponding to the immutability of the sub-format is guaranteed that the noise applied will not change the associated eye of the value. Thus, masking restrictions may automatically be detected for any composite formats with immutable sub-formats. The resulting masked values may therefore be within the format, containing left and right with values between −9 and 9 and containing exactly two decimal points, while also remaining within 5% of the domain size of the format, or a maximum change of 0.05(9−(−9))=0.90. Assuming in this example that a prescription can only be an integer, then the number of possible values may be −9 to 9, or 19 values, times two for the Left and Right eye. The domain of the format may thus have a size of 38. Therefore, without the Immutable masking restriction, the ranking may result in an integer in [0-37] and the cipher would return a cipher integer also in [0-37]. However, because of the masking restriction, in a received instance with a value of Left −1.0, only the −1 change and not the Left value. Thus, the ranking would only have 19 possible values. The size of the effective domain in this example would therefore be 19. The result of the ranking then would be an integer within [0-18], and the cipher would also return a perturbed integer within [0-18].

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional instances of formats, formats, noisy formats, or additional computing systems, etc.).

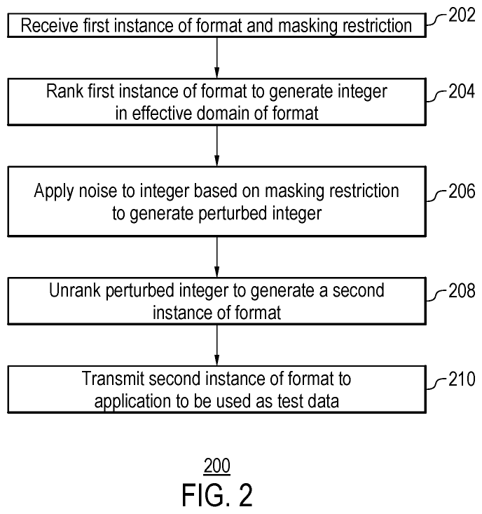

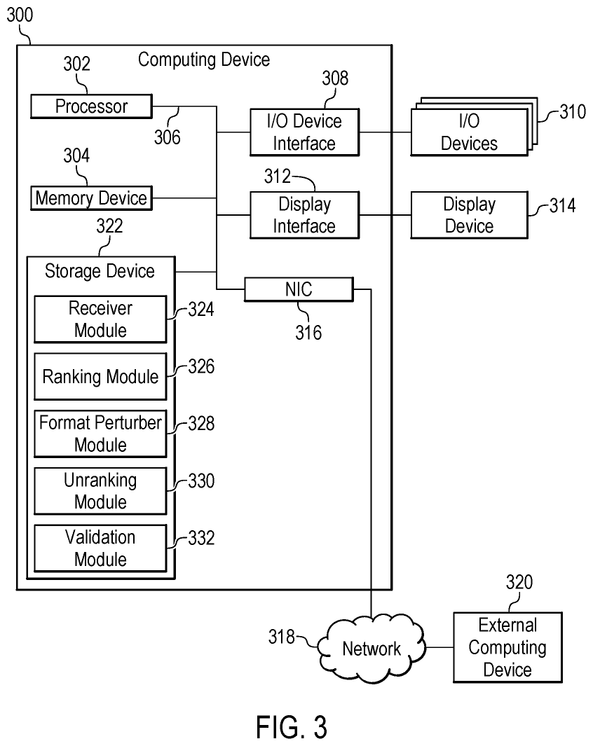

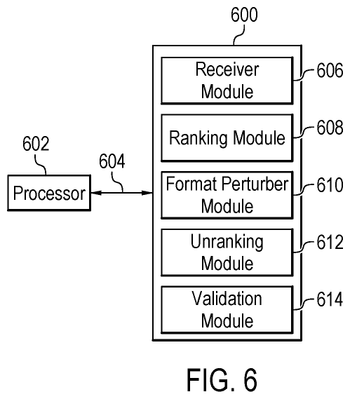

FIG. 2 is a process flow diagram of an example method that can mask formats with masking restrictions. The method 200 can be implemented with any suitable computing device, such as the computing device 300 of FIG. 3 and is described with reference to the systems 100 and 200 of FIGS. 1 and 2. For example, the methods described below can be implemented by the computing device 300 or using the computer-readable medium 600 of FIGS. 3 and 6.

At block 202, a first instance of a format and a masking restriction are received. For example, the first instance of the format may match the format and thus be a valid instance of the format. In some examples, a percentage of perturbation to be applied may also be received. For example, the percentage may be relative to a size of the effective domain of the format. In some examples, a default percentage may be used in response to not detecting any received percentage. For example, the default percentage may be any present percentage, such as 1%.

At block 204, the first instance of the format is ranked to generate an integer in an effective domain of the format. For example, the integer may be a number between the value zero and the value of the domain size of the format. In some examples, a composite ranking may be performed. For example, if the format is a composite format, then the ranking may take into account all possible valid instances of the composite format and rank the first instance of the composite format accordingly. In some examples, performing a composite ranking may involve the use of two or more types of ranking algorithms based on the building blocks that the composite format contains.

At block 206, noise is applied to the integer based on the masking restriction to generate a perturbed integer. For example, the integer may be perturbed within a percentage of a size of the effective domain of the format. In various examples, an effective domain for the format may be generated based on the masking restriction and the perturbed integer generated within the effective domain. For example, the effective domain of the format may be reduced from an original domain of the format by the masking restriction. In some examples, the integer may be perturbed within a range corresponding to a tile corresponding to the first instance of the format. In various examples, immutable sub-format values may be kept unchanged during application of the noise.

At block 208, the perturbed integer is unranked to generate a second instance of the format. For example, the perturbed integer may be used as an index to lookup the second instance of the format within the effective domain of the format. In various examples, the second instance of the format may be a second valid instance of the format that meets all format restrictions of the format.

At block 210, the second instance of the format is transmitted to an application to be used as test data. For example, an application may use the second instance of the format as part of a test data set to validate a trained machine learning model.

The process flow diagram of FIG. 2 is not intended to indicate that the operations of the method 200 are to be executed in any particular order, or that all of the operations of the method 200 are to be included in every case. Additionally, the method 200 can include any suitable number of additional operations, such as releasing data for analysis while adhering to regulations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 3 is block diagram of an example computing device that can mask formats with masking restrictions. The computing device 300 may be for example, a server, desktop computer, laptop computer, tablet computer, or smartphone. In some examples, computing device 300 may be a cloud computing node. Computing device 300 may be described in the general context of computer system executable instructions, such as program modules, being executed by a computer system. Generally, program modules may include routines, programs, objects, components, logic, data structures, and so on that perform particular tasks or implement particular abstract data types. Computing device 300 may be practiced in distributed cloud computing environments where tasks are performed by remote processing devices that are linked through a communications network. In a distributed cloud computing environment, program modules may be located in both local and remote computer system storage media including memory storage devices.

The computing device 300 may include a processor 302 that is to execute stored instructions, a memory device 304 to provide temporary memory space for operations of said instructions during operation. The processor can be a single-core processor, multi-core processor, computing cluster, or any number of other configurations. The memory 304 can include random access memory (RAM), read only memory, flash memory, or any other suitable memory systems.

The processor 302 may be connected through a system interconnect 306 (e.g., PCI®, PCI-Express®, etc.) to an input/output (I/O) device interface 308 adapted to connect the computing device 300 to one or more I/O devices 310. The I/O devices 310 may include, for example, a keyboard and a pointing device, wherein the pointing device may include a touchpad or a touchscreen, among others. The I/O devices 310 may be built-in components of the computing device 300, or may be devices that are externally connected to the computing device 300.

The processor 302 may also be linked through the system interconnect 306 to a display interface 312 adapted to connect the computing device 300 to a display device 314. The display device 314 may include a display screen that is a built-in component of the computing device 300. The display device 314 may also include a computer monitor, television, or projector, among others, that is externally connected to the computing device 300. In addition, a network interface controller (NIC) 316 may be adapted to connect the computing device 300 through the system interconnect 306 to the network 318. In some embodiments, the NIC 316 can transmit data using any suitable interface or protocol, such as the internet small computer system interface, among others. The network 318 may be a cellular network, a radio network, a wide area network (WAN), a local area network (LAN), or the Internet, among others. An external computing device 320 may connect to the computing device 300 through the network 318. In some examples, external computing device 320 may be an external webserver 320. In some examples, external computing device 320 may be a cloud computing node.

The processor 302 may also be linked through the system interconnect 306 to a storage device 322 that can include a hard drive, an optical drive, a USB flash drive, an array of drives, or any combinations thereof. In some examples, the storage device may include a receiver module 324, a ranking module 326, a format perturber module 328, an unranking module 330, and a validation module 332. The receiver module 324 can receive a first instance of a format and a masking restriction. For example, the format may be a composite format. In some examples, the format may have nested composite formats. In various examples, the masking restriction may be specified in the format. The ranking module 326 can rank the first instance of the format to generate an integer in an effective domain of the format. For example, the effective domain may be reduced from the original domain of the format by the masking restriction. For example, the effective domain may be an ordered set of possible valid values for the second instance of the format based on the first instance of the format. In some examples, the format may be a tiled format and the masking restriction may be keeping the second instance of the format within an original tile of the first instance. In these examples, an effective domain of the format may be a size of the tile. The format perturber module 328 can apply noise to the integer based on the masking restriction to generate a perturbed integer. For example, the perturbed integer may be a number within a percentage of the size of the effective domain of the format. In some examples, the ranking module 326 can rank the first instance of the format using a composite ranking. Thus, the ranking module 326 can generically apply noise to the first instance of the format by modifying the integer corresponding to the first instance of the format and generating the perturbed integer. The unranking module 330 can unrank the perturbed integer to generate a second instance of the format. For example, the second instance of the format may be a valid instance of the format within the masking restriction. The validation module 332 can validate an application using the second instance as test data.

It is to be understood that the block diagram of FIG. 3 is not intended to indicate that the computing device 300 is to include all of the components shown in FIG. 3. Rather, the computing device 300 can include fewer or additional components not illustrated in FIG. 3 (e.g., additional memory components, embedded controllers, modules, additional network interfaces, etc.). For example, the computing device 300 may have a transmitter module instead of the validation module and the second instance of the format may be transmitted to another computing device for use as test data, or any other suitable purpose. Furthermore, any of the functionalities of the receiver module 324, the ranking module 326, the format perturber module 328, the unranking module 330, and the validation module 332, may be partially, or entirely, implemented in hardware and/or in the processor 302. For example, the functionality may be implemented with an application specific integrated circuit, logic implemented in an embedded controller, or in logic implemented in the processor 302, among others. In some embodiments, the functionalities of the receiver module 324, the ranking module 326, the format perturber module 328, the unranking module 330, and the validation module 332 can be implemented with logic, wherein the logic, as referred to herein, can include any suitable hardware (e.g., a processor, among others), software (e.g., an application, among others), firmware, or any suitable combination of hardware, software, and firmware.

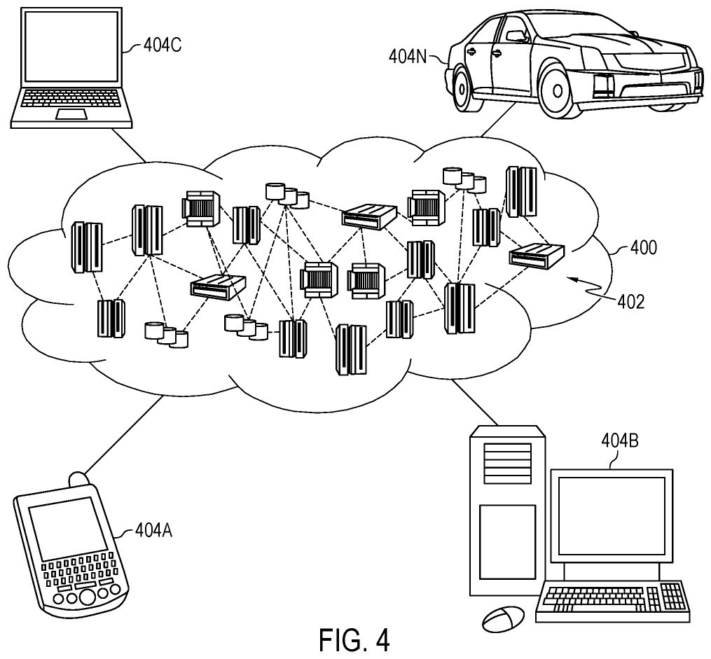

Referring now to FIG. 4, illustrative cloud computing environment 400 is depicted. As shown, cloud computing environment 400 includes one or more cloud computing nodes 402 with which local computing devices used by cloud consumers, such as, for example, personal digital assistant (PDA) or cellular telephone 404A, desktop computer 404B, laptop computer 404C, and/or automobile computer system 404N may communicate. Nodes 402 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 404A-N shown in FIG. 4 are intended to be illustrative only and that computing nodes 402 and cloud computing environment 400 can communicate with any type of computerized device over any type of network and/or network addressable connection (e.g., using a web browser).

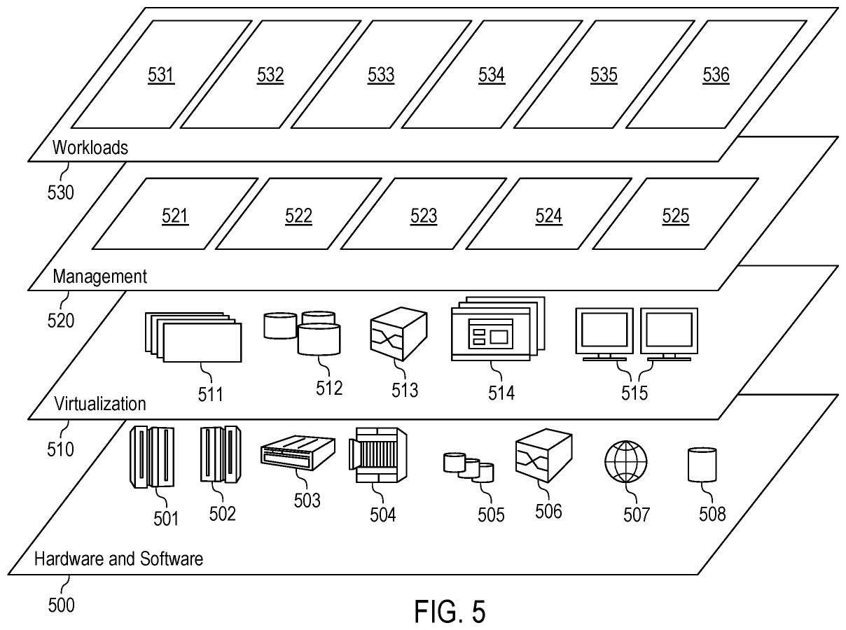

Referring now to FIG. 5, a set of functional abstraction layers provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 500 includes hardware and software components. Examples of hardware components include: mainframes 501; RISC (Reduced Instruction Set Computer) architecture based servers 502; servers 503; blade servers 504; storage devices 505; and networks and networking components 506. In some embodiments, software components include network application server software 507 and database software 508.

Virtualization layer 510 provides an abstraction layer from which the following examples of virtual entities may be provided: virtual servers 511; virtual storage 512; virtual networks 513, including virtual private networks; virtual applications and operating systems 514; and virtual clients 515.

In one example, management layer 520 may provide the functions described below. Resource provisioning 521 provides dynamic procurement of computing resources and other resources that are utilized to perform tasks within the cloud computing environment. Metering and Pricing 522 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 523 provides access to the cloud computing environment for consumers and system administrators. Service level management 524 provides cloud computing resource allocation and management such that required service levels are met. Service Level Agreement (SLA) planning and fulfillment 525 provide pre-arrangement for, and procurement of, cloud computing resources for which a future requirement is anticipated in accordance with an SLA.

Workloads layer 530 provides examples of functionality for which the cloud computing environment may be utilized. Examples of workloads and functions which may be provided from this layer include: mapping and navigation 531; software development and lifecycle management 532; virtual classroom education delivery 533; data analytics processing 534; transaction processing 535; and format masking 536.

The present invention may be a system, a method and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Referring now to FIG. 6, a block diagram is depicted of an example tangible, non-transitory computer-readable medium 600 that can mask formats with masking restrictions. The tangible, non-transitory, computer-readable medium 600 may be accessed by a processor 602 over a computer interconnect 604. Furthermore, the tangible, non-transitory, computer-readable medium 600 may include code to direct the processor 602 to perform the operations of the method 200 of FIG. 2.

The various software components discussed herein may be stored on the tangible, non-transitory, computer-readable medium 600, as indicated in FIG. 6. For example, a receiver module 606 includes code to receive a first instance of a format and a masking restriction. A ranking module 608 includes code to rank the first instance of the format to generate an integer in an effective domain of the format. For example, the effective domain of the format may be reduced from an original domain of the format by the masking restriction. In various examples, the ranking module 608 includes code to perform a composite ranking. For example, the format may be a composite format. A format perturber module 610 includes code to apply noise to the integer based on the masking restriction to generate a perturbed integer. The format perturber module 610 also includes code to generate the perturbed integer within an effective domain of the first instance of the format based on the masking restriction. In some examples, the format perturber module 610 also includes code to perturb the integer within a percentage of a size of the effective domain of the format. In various examples, the format perturber module 610 also includes code to perturb the integer within a range corresponding to a tile corresponding to the first instance of the format. For example, the format may be a tiled composite format. A unranking module 612 includes code to unrank the perturbed integer to generate a second instance of the format. A validation module 614 includes code to transmit the second instance of the format to an application to be used as test data. For example, the second instance of the format may be used as test data to validate a model. In some examples, the model may be a trained machine learning application.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIG. 6 may be included within the tangible, non-transitory, computer-readable medium 600, depending on the specific application.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive a first instance of a format and a masking restriction;
rank the first instance of the format to generate an integer in an effective domain of the format, wherein the effective domain of the format is reduced from an original domain of the format by the masking restriction;
apply noise to the integer based on the masking restriction to generate a perturbed integer; and
unrank the perturbed integer to generate a second instance of the format.

2. The system of claim 1, wherein the perturbed integer is a number within a percentage of a size of the effective domain of the format.

3. The system of claim 1, wherein the noise is generically applied to the first instance of the format by modifying the integer corresponding to the first instance of the format and generating the perturbed integer.

4. The system of claim 1, wherein the format comprises a composite format, and the processor is to rank the first instance of the format using a composite ranking.

5. The system of claim 1, wherein the second instance of the format comprises a valid instance of the format within the masking restriction.

6. The system of claim 1, wherein the effective domain comprises an ordered set of possible valid values for the format within the masking restriction based on the first instance of the format.

7. The system of claim 1, wherein the format comprises a tiled format and the masking restriction comprises keeping the second instance of the format within an original tile of the first instance, wherein an effective size of the effective domain of the format comprises a size of the tile.

8. A computer-implemented method, comprising:
receiving, via a processor, a first instance of a format and a masking restriction;
ranking, via the processor, the first instance of the format to generate an integer in an effective domain of the format, wherein the effective domain of the format is reduced from an original domain of the format by the masking restriction;
applying, via the processor, noise to the integer based on the masking restriction to generate a perturbed integer; and
unranking, via the processor, the perturbed integer to generate a second instance of the format.

9. The computer-implemented method of claim 8, wherein applying the noise comprises generating an effective domain for the first instance of the format based on the masking restriction and generating the perturbed integer within the effective domain.

10. The computer-implemented method of claim 8, wherein ranking the first instance of the format comprises performing a composite ranking, wherein the format comprises a composite format.

11. The computer-implemented method of claim 8, wherein applying the noise to the integer based on the masking restriction comprises perturbing the integer within a percentage of a size of the effective domain of the format.

12. The computer-implemented method of claim 8, wherein applying the noise to the integer based on the masking restriction comprises perturbing the integer within a range corresponding to a tile corresponding to the first instance of the format.

13. The computer-implemented method of claim 8, wherein applying the noise to the integer based on the masking restriction comprises keeping immutable sub-format values unchanged.

14. The computer-implemented method of claim 8, further comprising transmitting, via the processor, the second valid instance of the format to an application to be used as test data.

15. A computer program product for masking formats, the computer program product comprising a computer-readable storage medium having program code embodied therewith, wherein the computer-readable storage medium is not a transitory signal per se, the program code executable by a processor to cause the processor to:
receive a first instance of a format and a masking restriction;
rank the first instance of the format to generate an integer in an effective domain of the format, wherein the effective domain of the format is reduced from an original domain of the format by the masking restriction;
apply noise to the integer based on the masking restriction to generate a perturbed integer; and
unrank the perturbed integer to generate a second instance of the format.

16. The computer program product of claim 15, further comprising program code executable by the processor to generate the perturbed integer within the effective domain of the format based on the masking restriction.

17. The computer program product of claim 15, further comprising program code executable by the processor to perform a composite ranking, wherein the format comprises a composite format.

18. The computer program product of claim 15, further comprising program code executable by the processor to perturb the integer within a percentage of a size of the effective domain of the format.

19. The computer program product of claim 15, further comprising program code executable by the processor to perturb the integer within a range corresponding to a tile corresponding to the instance of the format, wherein the format comprises a tiled composite format and the effective domain comprises the tile of the instance.

20. The computer program product of claim 15, further comprising program code executable by the processor to transmit the second instance of the format to an application for use as test data.
